(19) United States
(12) Patent Application Publication
(10) Pub. No.: US 2017/0038142 A1
(43) Pub. Date: Feb. 9, 2017

(54) Camp Fire Boot Drier

(71) Applicant: Cody L. Schwegel, Craig, AK (US)

(72) Inventor: Cody L. Schwegel, Craig, AK (US)

(21) Appl. No.: 14/817,526

(22) Filed: Aug. 4, 2015

(51) Int. Cl. F26B 9/00; F26B 9/10; A47L 23/20; F26B 21/00

(52) U.S. Cl. CPC F26B 9/003; F26B 21/006; F26B 9/10; A47L 23/20

(57) ABSTRACT

The present invention provides an apparatus for drying apparels. It works without electricity and gas. It is basically for using while camping. It is an apparatus that uses natural convection for drying boots, gloves, shoes, socks and etc. It is designed to use the energy of campfire to function. Users just have to put dryer in the front of the fire and it draws hot air into the telescopic base and the hot air raises causing air movement. It gives ability to dry the boots without propane or electricity. Dimension of the drier is twelve inches wide, eighteen inches tall and three inches thick. It is portable and collapsible apparel dryer. It is made up of aluminum tubes.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to a device for drying articles of clothing. More specifically, the present invention relates to a compact and portable drying apparatus for use while camping

(2) Background of the Invention

The prior art, going back over 100 years, is replete with clothing, boot, and glove dryers designed primarily for home use. These dryers tend to be bulky and difficult to store when they are not needed. All are unsuitable for use while camping, hiking, backpacking, or participating other outdoor applications.

The vast majority of the prior art offers designs that include some means for capturing air that has been heated and then providing a means for ducting the heated air to the article of clothing to be dried. For example, in 1899, Witmer (U.S. Pat. No. 629,944) discloses a sheet metal boot drier that has a pair of tubes that extend upward from openings in a lower plenum. The tubes are positioned to receive the inverted boots to be dried. In use, the plenum collects air heated by a lamp. The air is then transferred to the tubes to heat and dry the boots. Although Witmer's design is suitable for outdoor use, it is not sufficiently compact for efficient storage or easy transport

A few years later, Peabody discloses, in (U.S. Pat. No. 859,514), a truncated conical boot drying apparatus. The base of the sheet metal cone is placed on a heated surface, and a single boot is then inverted and placed over the upper portion of the cone. Air holes are provided near the base of the cone to admit air to the interior of the cone, which is then heated and carried to the interior of the boot by convection. To promote air circulation through the interior of the boot, Peabody provides an upward projecting external U-shaped tube, one leg of which is affixed to the outside of the cone. The distal end of this leg extends into the boot. The other leg projects upward on the outside of the boot. In this fashion, heated air within the boot is exhausted downward through the leg that is attached to the side of the cone, and then upward through the other leg. As in Witmer's design, Peabody's apparatus is not compact and is generally unsuitable for most outdoor applications.

A large number of non-portable and relatively bulky shoe, boot, and glove drying devices have been disclosed that generally provide a means for gathering heated air from a home's floor or wall register and then ducting the heated air to the interior of the glove or boot. The ducting means typically supports the article of clothing to be dried.

Petre, in (U.S. Pat. No. 4,530,168), discloses a combination boot carrying and drying device that removably attaches to a boot that, in turn, removably attaches to a wall bracket that is placed immediately above a home's heating register. The fixture, which is adjustable for different sized boots, may be used to carry the boots when they are not being dried.

There is a prior art, (U.S. Pat. No. 5,692,316), which discloses a plurality of shaped wire holding units that are positioned on at least two hardwood base pieces that provide stability for the assembled apparatus. The holding units are designed to rotate within the base pieces to allow the apparatus to be stored in a flattened position. The holding units are secured in vertical holes in the wooden base pieces by push nuts, and are also able to be rotated. The holding units are formed from wire in various shapes to accommodate different articles of apparel. This apparatus is designed to fit over air ducts (registers) and baseboard heaters. The apparatus further includes a means to adapt to various baseboard heights. Although this disclosure is designed to be flattened for storage, from the nature of the relatively large hardwood base pieces, this invention does not have the portability and compactness required for easy transport and outdoor applications. In addition to this problem, the wooden base units could present a fire danger when used while camping.

Two utility patents disclose apparel drying apparatus that do not depend on heated air from a home heating system. The first, Guindon (U.S. Pat. No. 5,058,289), describes a dryer that has a base unit that incorporates a heating coil and a blower. The apparel, e.g. boots, are fitted over hollow, bellows-type drying tubes. These tubes connect with the interior of the base unit to receive forced, heated air to dry the apparel. The second approach, disclosed by Jannach (U.S. Pat. No. 5,862,606), discloses a device for drying protective suits. This device consists of a plurality of hollow tubes that are formed to support the arms and legs of the suit in an inverted fashion. The tubes are connected to a blower, which supplies heated air (the heat source is not disclosed). Holes in the tubes are provided at appropriate locations to vent the air after it has provided heat to the suit.

From the above discussion, it is dear that there are no apparel drying devices that have the attributes required for compact storage and lightweight transport for camping, hiking, fishing, and backpacking applications. For such applications, an apparel dryer is needed for boots, shoes, gloves, mittens, and so forth that can readily be transported and erected by a single individual. As such, this apparatus needs to be compact and lightweight, yet rugged to withstand the rigors of outdoor use.

The present invention attempts to alleviate the above problems. A new apparel drier is introduced for using while camping. The drier works without electricity and gas. Users ran use it for drying boots, shoes gloves, and other apparels while camping.

### SUMMARY OF THE INVENTION

In the view of the foregoing disadvantages inherent in the known types of driers now present in the prior art, the present invention provides an improved drier for drying apparels while camping. As such, the general purpose of the present invention, which will be described subsequently in greater detail, is to provide a new and improved drier that has all of the advantages of the prior art, and none of the disadvantages.

The primary objective of the present invention is to provide a novel drier that uses the convection heat of a campfire, as per the preferred embodiment of the present invention.

It is, therefore, an objective of the present invention to provide a portable apparel drier, as per the preferred embodiment of the present invention.

It is a further objective of the present invention to provide a collapsible apparel drier, as per the preferred embodiment of the present invention.

It is, therefore, an objective of the present invention to provide an apparel drier that works without electricity and gas, as per the preferred embodiment of the present invention.

It is a further objective of the present invention to provide an apparel drier that prevents shoes from melting, as per the preferred embodiment of the present invention.

It is another objective of the present invention to provide a lightweight apparel drier, as per the preferred embodiment of the present invention.

It is, therefore, an objective of the present invention to provide an apparel drier that has a heat shield (5), which provides heat to the apparel, as per the preferred embodiment of the present invention.

It is a further objective of the present invention to provide an aluminum apparel drier, as per the preferred embodiment of the present invention.

Another objective of the present invention is to provide an apparel drier that will be economical to manufacture and easy to implement, as per the preferred embodiment of the present invention.

In this respect, before explaining at least one embodiment of the invention in detail, it is to be understood that the invention is not limited in its application to the details of construction and to the arrangements of the components set forth in the following description Of illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying descriptive matter, in which there are illustrated preferred embodiments of the invention.

Accordingly, the present disclosure includes features and advantages that are believed to enable it to advance the art of placing items on carriers. Characteristics and advantages of the present disclosure described above, along with the additional features and benefits, will be readily apparent to those skilled in the art upon consideration of the following detailed description and the accompanying drawings.

### BRIEF DESCRIPTION OF THE FIGURES

The invention will be better understood and objects other than those set forth above will become apparent when consideration is given to the following detailed description thereof. Such description makes reference to the annexed drawings wherein:

FIG. 1 shows the perspective view of the invention.

FIG. 2 shows the perspective view of the support system and the heat flow mechanism used in the invention.

FIG. 3 shows the perspective view of the invention identifying different components of the invention.

### DETAILED DESCRIPTION OF THE INVENTION

In the following detailed description, many embodiments are described, as per the invention. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended description and their equivalents.

As per the present invention, an outdoor camping accessory is provided The present invention is an apparel drier that can be used while camping. It is an apparatus for drying apparels. Its main feature is that it does not require electricity or gas to work. It is an apparatus that uses natural convection to dry boots, shoes, socks, gloves, etc. It is designed to use the energy of a campfire to function. By placing the boot drier in the front of fire, it draws hot air into the telescopic base (1), and the hot air rises, which causes air movement. It gives the ability to dry boots without relying on propane or electricity. It is also portable and collapsible. Users can take it with them anywhere quite easily. It is 12 inches wide, 18 inches tall, and 3 inches thick. The apparatus is made from aluminum tube. The apparatus has button-lock, metal spring band latches to help it lock into the erected and collapsed form.

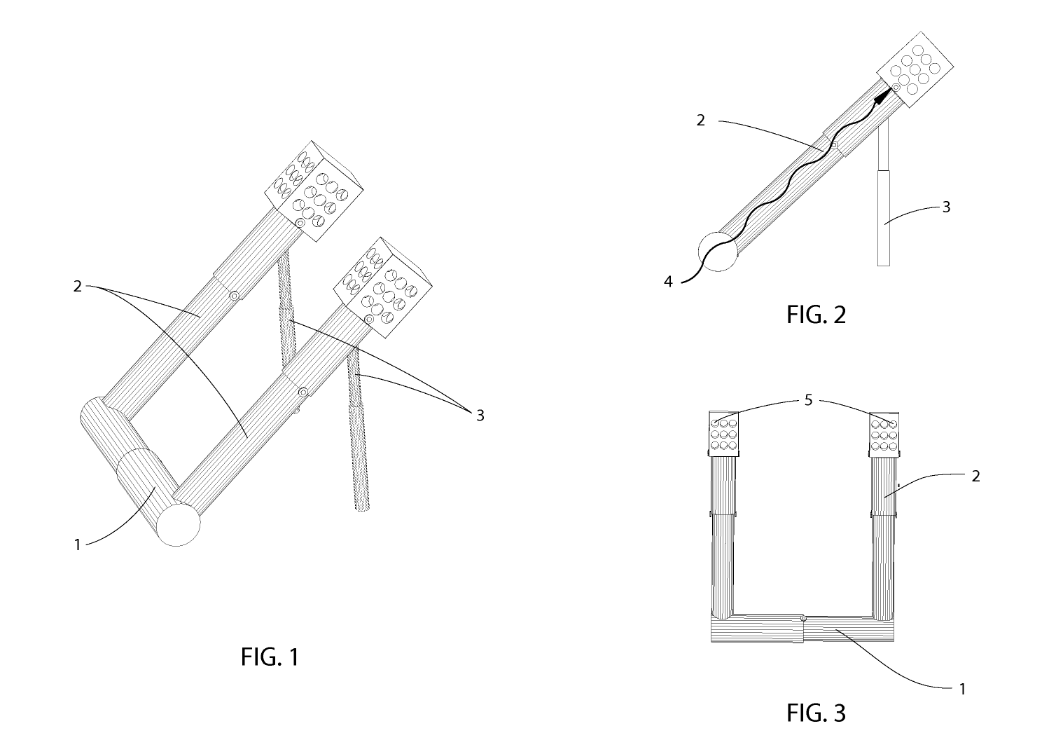

FIG. 1 illustrates the telescopic base (1) for holding the telescopic arms (2). Two telescopic arms (2), with two ends, are placed on the telescopic base (1). The telescopic arms (2) are used for flowing the heat (4) towards the apparels, which dries them. Two telescopic support arms (3) are in the midway of the telescopic arms (2). These support the telescopic arms (2). Button latches are used for locking the telescopic arms (2) with each other. Two heat shields (5) are included to provide heat to the apparels. The telescopic arms (2) are in a U-shape formation, for receiving the apparels. Further referring to the FIG. 2 and FIG. 3 identifies the different components of the apparatus for example the telescopic base (1), the telescopic arms (2), telescopic support arms (3), heat shields (5) and mechanism of the heat flow (4) that passes through the telescopic base, the telescopic arms (2) and the heat shields (5).

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. An apparel drying apparatus that is comprised of:
a first telescopic arm with two ends;
a second telescopic arm with a first end and a second end;
a telescopic support arm approximately midway between the telescopic arm;
a telescopic base with two ends;
a heat shield which connects at one end of the telescopic arm; and
a button latch for locking telescopic arms.

2. The apparel drying apparatus of claim 1, wherein said telescopic arms are first and second apparel holding telescopic arms.

3. The apparel drying apparatus of claim 1, wherein said first telescopic arm is pivotally connected to said first end of said telescopic base, and said second telescopic arm is pivotally connected to said second end of the said telescopic base.

4. The apparel drying apparatus of claim 1, wherein at least one said apparel holding telescopic arm is generally a flat U-shaped member for being inserted into a boot.

5. The apparel drying apparatus of claim 1, wherein having at least one said telescopic arm for flowing the heat to the apparel.

6. The apparel drying apparatus of claim 1, wherein at least one said latch button is for locking the said apparel holding telescopic arms.

7. The apparel drying apparatus of claim 1 wherein there is at least one said telescopic base for holding the said telescopic arms.

8. The apparel drying apparatus of claim 1, wherein said telescopic support arms are at least two in number.

9. The apparel drying apparatus of claim 2, wherein said telescopic support arms are removably connected to said apparel holding telescopic arm.

10. The apparel drying apparatus of claim 2, wherein having at least two said heat shield.

11. The apparel drying apparatus of claim 2, wherein said heat shields are removably connected to said apparel holding telescopic arm.
